(19) United States
(12) Patent Application Publication
(10) Pub. No.: US 2019/0088040 A1
(43) Pub. Date: Mar. 21, 2019

(54) EMERGENCY HAZARD LIGHT USER ASSIST

(71) Applicant: FORD GLOBAL TECHNOLOGIES, LLC, Dearborn, MI (US)

(72) Inventors: Anthony MELATTI, Dearborn, MI (US); Patrick Lawrence Jackson VAN HOECKE, Dearborn, MI (US); Hamid M. GOLGIRI, Dearborn, MI (US); Danielle ROSENBLATT, Dearborn, MI (US)

(21) Appl. No.: 15/707,150

(22) Filed: Sep. 18, 2017

(51) Int. Cl. G07C 5/00; G07C 5/08; H04L 29/08

(52) U.S. Cl. CPC G07C 5/006; G07C 5/0825; H04L 67/1097; G07C 5/0808; G07C 5/008

(57) ABSTRACT

A vehicle includes a controller programmed to, responsive to activation of a hazard warning system, cause a nomadic device that is in wireless communication with the controller, to display a list of options for responding to a vehicle condition. The controller is further programmed to, responsive to receiving a signal indicative of a selected list item from the nomadic device, cause the nomadic device to display content associated with the selected list item.

### TECHNICAL FIELD

This application generally relates to a driver assistance feature to provide more detailed information to drivers in the event of emergency conditions.

### BACKGROUND

Drivers of automotive vehicles may encounter a variety of situations while driving. In many cases, the drivers are aware of the proper response to a given situation. However, situations may arise in which the drive is unfamiliar with a proper course of action. The driver may be unaware of an appropriate response to certain situations. For example, the driver may be unware of a specific action that may be required when a warning lamp is present. The driver's initial response may be to consult a printed copy of the vehicle owner's manual. However, if the owner's manual is not conveniently in the vehicle, the driver may be unable to access the information. In this situation, the driver may have difficulty in determined the proper course of action.

### SUMMARY

A vehicle includes a wireless transceiver configured to communicate with a nomadic device. The vehicle further includes a controller programmed to, responsive to activation of vehicle hazard lamps, transmit an assistance request to the nomadic device, and, responsive to receiving a request for assistance from the nomadic device, transmit a list of options for display on the nomadic device, and, responsive to receiving a selected option, transmit content to the nomadic device related to the selected option.

The vehicle may further in include a display and the controller may be further programmed to output the list and the content to the display. The content may be stored in a non-volatile memory of the controller. The vehicle may further include a cellular modem and the controller may be further programmed to, responsive to receiving the request for assistance, download the list of options from a remote server via the cellular modem, and, responsive to receiving input indicative of a selected option, download the content related to the selected option from the remote server. The controller may be further programmed to prioritize the list of options such that options associated with a diagnostic trouble code that is presently illuminating an indicator light are displayed at topmost positions of the list. The wireless transceiver may be configured as a BLUETOOTH transceiver. The wireless transceiver may be configured as a wireless Ethernet transceiver.

A vehicle communication system includes a controller programmed to, responsive to activation of vehicle hazard lamps, transmit to a nomadic device a list of options such that options associated with a diagnostic trouble code that is presently causing an indicator to illuminate are prioritized first in the list, and responsive to input from the nomadic device indicating a selected list item, transmit content to the nomadic device related to the selected list item.

The controller may be further programmed to download the list of options and the content from a remote server using a cellular modem.

A method includes causing, by a vehicle controller, a nomadic device paired with a vehicle wireless transceiver to display a list of options associated with a diagnostic trouble code that is presently illuminating an indicator light responsive to activation of vehicle hazard lights. The method further includes communicating, by the nomadic device, a selected list item to the vehicle controller. The method further includes causing, by the vehicle controller, the nomadic device to display content associated with the selected list item.

The vehicle controller may transmit the content to the nomadic device. The vehicle controller may transmit a link to the content and the nomadic device retrieves the content via a network interface using the link.

The content may include step-by-step instructions and images related to the selected option. The content may include video related to the selected option. The list of options includes one or more observable vehicle conditions. The content may be directed toward responding to the observable vehicle condition that is the selected option.

The systems and methods to be described provide advantages as driver assistance is provided to the driver when a potential hazardous condition is recognized. The system can provide useful instructions to a driver in the event of the hazardous condition. As the information is displayed on a nomadic device, the driver may have access to the instructions while moving outside of the vehicle. For example, the driver assistance system may provide instructions for changing a tire such that the instructions are accessible outside of the vehicle while the driver is attempting repairs.

### BRIEF DESCRIPTION OF THE DRAWINGS

FIG. 1 is a possible configuration of a vehicle communication system.

FIG. 2 is a possible configuration of a hazard warning system that interfaces with the vehicle communication system.

FIG. 3 is a flowchart for a possible sequence of operations for providing a driver assistance features.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

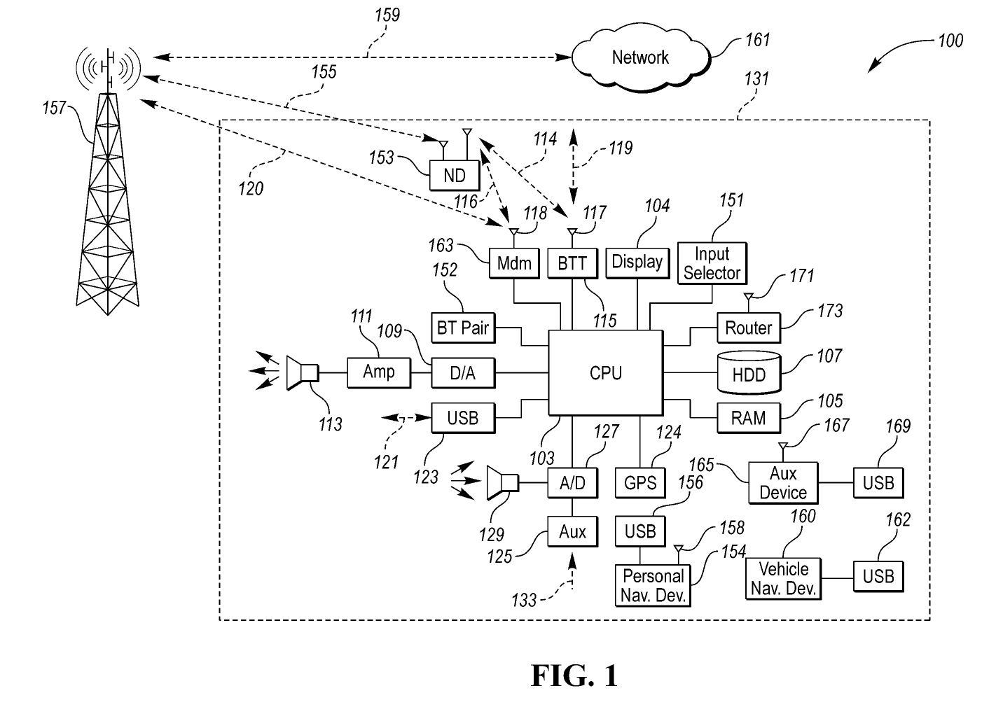

FIG. 1 illustrates an example block topology for a vehicle-based computing system 100 (VCS) for a vehicle 131. An example of such a vehicle-based computing system 100 is the SYNC system manufactured by THE FORD MOTOR COMPANY. The vehicle 131 enabled with the vehicle-based computing system 100 may contain a visual front end interface 104 located in the vehicle 131. The user may be able to interact with the interface 104 if it is provided, for example, with a touch sensitive screen. In another illustrative embodiment, the interaction occurs through, button presses, spoken dialog system with automatic speech recognition and speech synthesis.

In the illustrative embodiment shown in FIG. 1, at least one processor 103 controls at least some portion of the operation of the vehicle-based computing system 100. Provided within the vehicle 131, the processor 103 allows onboard processing of commands and routines. Further, the processor 103 is connected to both non-persistent 105 and persistent storage 107. In this illustrative embodiment, the non-persistent storage 105 is random access memory (RAM) and the persistent storage 107 is a hard disk drive (HDD) or flash memory. Non-transitory memory may include both persistent memory and RAM. In general, persistent storage 107 may include all forms of memory that maintain data when a computer or other device is powered down. These include, but are not limited to, HDDs, CDs, DVDs, magnetic tapes, solid state drives, portable USB drives and any other suitable form of persistent memory.

The processor 103 may also include several different inputs allowing the user and external systems to interface with the processor 103. The vehicle-based computing system 100 may include a microphone 129, an auxiliary input port 125 (for input 133), a Universal Serial Bus (USB) input 123, a Global Positioning System (GPS) input 124, a screen 104, which may be a touchscreen display, and a BLUETOOTH input 115. The VCS 100 may further include an input selector 151 that is configured to allow a user to swap between various inputs. Input from both the microphone 129 and the auxiliary connector 125 may be converted from analog to digital by an analog-to-digital (A/D) converter 127 before being passed to the processor 103. Although not shown, numerous of the vehicle components and auxiliary components in communication with the VCS may use a vehicle network (such as, but not limited to, a Controller Area Network (CAN) bus, a Local Interconnect Network (LIN) bus, a Media Oriented System Transport (MOST) bus, an Ethernet bus, or a FlexRay bus) to pass data to and from the VCS 100 (or components thereof).

Outputs from the processor 103 may include, but are not limited to, a visual display 104 and a speaker 113 or stereo system output. The speaker 113 may be connected to an amplifier 111 and receive its signal from the processor 103 through a digital-to-analog (D/A) converter 109. Outputs can also be made to a remote BLUETOOTH device such as a Personal Navigation Device (PND) 154 or a USB device such as vehicle navigation device 160 along the bi-directional data streams shown at 119 and 121 respectively.

In one illustrative embodiment, the system 100 uses the BLUETOOTH transceiver 115 with an antenna 117 to communicate with a user's nomadic device 153 (e.g., cell phone, smart phone, Personal Digital Assistance (PDA), or any other device having wireless remote network connectivity). The nomadic device 153 can then be used to communicate over a tower-network communication path 159 with a network 161 outside the vehicle 131 through, for example, a device-tower communication path 155 with a cellular tower 157. In some embodiments, tower 157 may be a wireless Ethernet or WiFi access point as defined by Institute of Electrical and Electronics Engineers (IEEE) 802.11 family of standards. Exemplary communication between the nomadic device 153 and the BLUETOOTH transceiver 115 is represented by Bluetooth signal path 114.

Pairing the nomadic device 153 and the BLUETOOTH transceiver 115 can be instructed through a button 152 or similar input. Accordingly, the CPU is instructed that the onboard BLUETOOTH transceiver 115 will be paired with a BLUETOOTH transceiver in a nomadic device 153.

Data may be communicated between CPU 103 and network 161 utilizing, for example, a data-plan, data over voice, or Dual Tone Multi Frequency (DTMF) tones associated with nomadic device 153. Alternatively, it may be desirable to include an onboard modem 163 having antenna 118 in order to establish a vehicle-device communication path 116 for communicating data between CPU 103 and network 161 over the voice band. The nomadic device 153 can then be used to communicate over the tower-network communication path 159 with a network 161 outside the vehicle 131 through, for example, device-tower communication path 155 with a cellular tower 157. In some embodiments, the modem 163 may establish a vehicle-tower communication path 120 directly with the tower 157 for communicating with network 161. As a non-limiting example, modem 163 may be a USB cellular modem and vehicle-tower communication path 120 may be cellular communication.

In one illustrative embodiment, the processor 103 is provided with an operating system including an application programming interface (API) to communicate with modem application software. The modem application software may access an embedded module or firmware on the BLUETOOTH transceiver 115 to complete wireless communication with a remote BLUETOOTH transceiver (such as that found in a nomadic device 153). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Other wireless communication means that can be used in this realm is free-space optical communication (such as IrDA) and non-standardized consumer IR protocols or inductive coupled means including but not limited to near-field communications systems such as RFID.

In another embodiment, nomadic device 153 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Division Multiple Access (CDMA), Time Division Multiple Access (TDMA), Space-Division Multiple Access (SDMA) for digital cellular communication, including but not limited to Orthogonal Frequency-Division Multiple Access (OFDMA) which may include time-domain statistical multiplexing. These are all International Telegraph Union (ITU) International Mobile Telecommunication (IMT) 2000 (3G) compliant standards and offer data rates up to 2 Mbps for stationary or walking users and 385 Kbps for users in a moving vehicle. 3G standards are now being replaced by IMT-Advanced (4G) which offers 100 Mbps for users in a vehicle and 1 Gbps for stationary users. If the user has a data-plan associated with the nomadic device 153, it is possible that the data-plan allows for broad-band transmission and the system could use a much wider bandwidth (speeding up data transfer). In still another embodiment, nomadic device 153 is replaced with a cellular communication device (not shown) that is installed to vehicle 131. In yet another embodiment, the nomadic device 153 may be a wireless local area network (LAN) device capable of communication over, for example (and without limitation), an IEEE 802.11g network (i.e., WiFi) or a WiMax network.

In one embodiment, incoming data can be passed through the nomadic device 153 via a data-over-voice or data-plan, through the onboard BLUETOOTH transceiver 115 and to the vehicle's internal processor 103. In the case of certain temporary data, for example, the data can be stored on the HDD or other storage media 107 until the data is no longer needed.

Additional sources that may interface with the vehicle 131 include a personal navigation device 154, having, for example, a USB connection 156 and/or an antenna 158, a vehicle navigation device 160 having a USB 162 or other connection, an onboard GPS device 124, or remote navigation system (not shown) having connectivity to network 161. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU 103 may be in communication with a variety of other auxiliary devices 165. The auxiliary devices 165 can be connected through a wireless (e.g., via auxiliary device antenna 167) or wired (e.g., auxiliary device USB 169) connection. Auxiliary devices 165 may include, but are not limited to, personal media players, wireless health devices, portable computers, and the like.

Also, or alternatively, the CPU 103 may be connected to a vehicle-based wireless router 173, using for example a WiFi (IEEE 802.11) transceiver/antenna 171. This may allow the CPU 103 to connect to remote networks in range of the local router 173. In some configurations, the router 173 and the modem 163 may be combined as an integrated unit. However, features to be described herein may be applicable to configurations in which the modules are separate or integrated.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments, particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

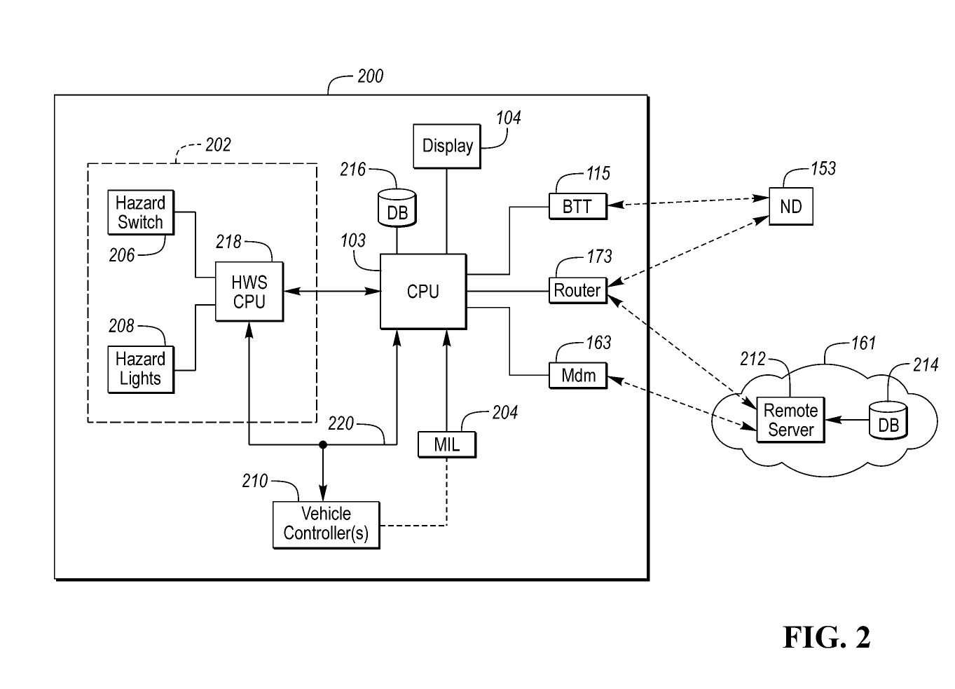

FIG. 2 depicts a configuration of a vehicle 200 that includes a hazard warning system 202. The vehicle 200 may include the vehicle-based computing system 100 described herein. The hazard warning system 202 may be configured to provide a visible and/or audible warning to vehicle occupants and those near the vehicle 200. The hazard warning system 202 may include a hazard warning system (HWS) controller 218 (e.g., HWS CPU). The HWS controller 218 may include a microprocessor and volatile and non-volatile memory. In some configurations, the HWS controller 218 may be incorporated into a controller that controls additional vehicle features. The HWS controller 218 may include circuity configured to interface with electrical components of the hazard warning system 202. The CPU 103 may interface to one or more wireless transceivers (e.g., BLUETOOTH 115 and/or router 173).

The hazard warning system 202 may include one or more hazard lights 208. The HWS controller 218 may be operatively coupled to the hazard lights 208 such that the HWS controller 218 may cause the hazard lights 208 to turn on and off. The hazard lights 208 may include visible lighting devices on the exterior of the vehicle. For example, the hazard lights 208 may include tail lights of the vehicle 200. The hazard lights 208 may be flashed at a predetermined rate to attract attention of others outside of vehicle 200. The hazard warning system 202 may include a hazard switch 206 which may be a switch or push button in an interior of the vehicle 200. The HWS controller 218 may be operatively coupled to the hazard switch 206 such that the HWS controller 218 receives one or more signals indicating the state of the hazard switch 206. Pressing the hazard switch 206 may trigger activation of the hazard lights 208. A subsequent pressing of the hazard switch 206 may deactivate hazard lights 208. A vehicle occupant may activate the hazard warning system 202 in the event of an emergency or other unsafe condition. For example, the hazard warning system 202 may be used after an accident or when the vehicle is disabled on or near the road. The hazard warning system 202 alerts other drivers of the presence of the vehicle and that the vehicle may not be operating in a normal manner.

The vehicle 200 may include additional vehicle controllers 210 that operate various features of the vehicle 200. For example, a powertrain controller may operate components relating to the powertrain. The vehicle controllers 210 may be in communication with the CPU 103 via a vehicle communications network 220 (e.g., CAN bus or other network). The vehicle controllers 210 may monitor the operational status of the associated system and components. The vehicle controllers 210 may monitor for conditions in which the associated system is not fully operational. The vehicle controllers 210 may detect a condition in which the system is not capable of functioning at peak capacity. The vehicle controllers 210 may store a diagnostic trouble code (DTC) in response detecting the condition. The DTC may be stored in non-volatile memory and may be encoded to identify the particular condition that caused the DTC. The DTC may further trigger activation of a malfunction indicator light (MIL) 204 within the vehicle 200. Under normal operating conditions, the MIL 204 may be in the off state. The MIL 204 may be activated under control of the vehicle controllers 210. In some configurations, a selected controller may manage the MIL 204 and illuminate and extinguish the MIL 204 based on requests from the vehicle controllers 210 over the vehicle network 220. The status of the MIL 204 may be transmitted on the vehicle network 220 for use by the vehicle controllers 210 and/or the CPU 103.

If the DTC occurs during driving, the MIL 204 may be illuminated. A driver upon observing that the MIL 204 is illuminated may decide to stop the vehicle 200 to investigate the cause of the MIL 204. For example, the driver observing that the MIL 204 is illuminated, may drive the vehicle 200 to the side of the road and stop. To alert others, the driver may activate the hazard warning system 202 by pressing the hazard switch 206 to activate the hazard lights 208. The driver may consult the operator manual or other reference to determine the cause of the MIL 204.

The CPU 103 may be configured to request diagnostic information from the vehicle controllers 210. The vehicle controllers 210 may implement a diagnostic protocol for retrieving and managing diagnostic information. The CPU 103 may transmit requests DTC information to each of the vehicle controllers 210. The CPU 103 may periodically request DTC information or may request the DTC information based on predetermined trigger conditions.

In other scenarios, the driver may experience situations and/or vehicle conditions that prompt the driver to pull off to the side of the road and activate the hazard warning system 202. For example, a flat tire may cause the vehicle 200 to pull to one side or shake/vibrate. The driver may pull over to investigate the condition. In this case, there may not be a DTC stored that triggers the MIL 204. Many other scenarios may be devised in which the vehicle operator feels the need to activate the hazard warning system.

The vehicle driver may desire to investigate the problem by consulting the vehicle owner's manual which may normally be carried in the vehicle 200. However, for a variety of reasons, the vehicle 200 may be operating without the vehicle owner's manual being present. Without further guidance or advice, the driver may be unable to investigate vehicle problem that prompted stopping. With the advent of modern vehicle electronics and connectivity, it is possible to improve the situation.

For example, the vehicle owner's manual may be stored in persistent storage 107 for retrieval and display. The CPU 103 may be configured to present the stored owner's manual on the display 104. In some configurations, the display 104 may be a touch-screen that is configured to provide input based on contact with specified positions of the screen. In some configurations, the display 104 may include buttons along the screen periphery for selecting adjacent items displayed on the screen. For example, the CPU 103 may cause the display 104 to display various menus and sub-menus in which one selection is to view the operator's manual. Selecting this option, may cause the CPU 103 to display the operator's manual on the display 104. The system may be configured so that the operator may scroll through the contents of the operator's manual. This mode has limitations, as the operator must actively scroll through the contents to find the corresponding topic.

The CPU 103 may be configured to, in response to activation of the hazard warning system 202, prompt the operator if additional assistance is desired. For example, the CPU 103 may output a query to the operator to enable a user assist feature via the display 104. The CPU 103 may configure the screen to output a “yes” and a “no” selection button. If the user selects the “no” selection button, the display 104 may be returned to the previous display mode.

If the user selects the “yes” selection button, the CPU 103 may output a list of selectable items to the display 104. The list may be a predetermined list with more frequently requested items toward the top. In some configurations, the list may be context-sensitive. For example, the CPU 103 may check to see if any DTCs are present. The CPU 103 may transmit requests to the vehicle controllers 210 to retrieve DTC information. In addition, the CPU 103 may request other diagnostic information from the vehicle controllers 210. For example, the CPU 103 may request historical DTC information to identify if a DTC has happened previously. The CPU 103 may further retrieve logged data associated with each of the DTCs. For example, vehicle controllers 210 may store a snapshot of vehicle operating conditions when a DTC occurs (e.g., vehicle speed, gear, engine speed). Further, the CPU 103 may determine if any DTCs are active that caused the MIL 204 to illuminate. The CPU 103 may query the vehicle controllers 210 for DTC information and status of the MIL 204 over the vehicle network 220. The list may be sorted such that issues associated with an active DTC are presented first. The list may then include items associated with inactive DTCs followed by generic issues.

In some configurations, the CPU 103 may be programmed to output additional queries to the display. For example, the CPU 103 may implement a troubleshooting algorithm that attempts to query the operator to identify the information that is desired. For example, the CPU 103 may output a list of generic conditions. For example, the list may include an item regarding a warning lamp. The list may include an item about changes to the ride and handling of the vehicle. The list may include an item about a flat tire. The list may be touch-sensitive so that the operator may select an item by touching the listed item. In response to selecting an item, another list of queries or selections may be presented to try and narrow the issue.

The operator may scroll through the list to select the desired list item. For example, the operator may select the list item at the top of the list. In response to selecting a list item, the CPU 103 may be configured to output a set of instructions associated with the selected list item to the display 104. The instructions may be a text list of step-by-step instructions. The instructions may include images and video. The system may be configured to permit the operator to scroll through the instructions, pause the instructions, forward and reverse the instructions, and stop the instructions and return to the list.

The nomadic device 153 may be paired with the vehicle computing system 100. For example, the nomadic device may be paired through the BLUETOOTH interface 115 or the wireless router 173. The CPU 103 may direct output to the nomadic device 153 for display. The nomadic device 153 may implement an application or program for interfacing with the vehicle communication system. For example, the user assist query, the selectable list, and instructions may be output to the nomadic device 153 via the wireless connection. The application executed on the nomadic device 153 may receive the messages and convert the messages to data for display. The CPU 103 may be configured to communicate with the nomadic device 153 when the nomadic device 153 is paired with the nomadic device 153. In some configurations, the CPU 103 may attempt to establish communication with a previously paired nomadic device in response to activation of the hazard warning system 202. The operator may then perform the same operations as described previously. For example, a selection made by the nomadic device user on the touchscreen of the nomadic device 153 may be communicated via the wireless connection to the CPU 103.

As an example, the vehicle 200 may experience a flat tire during a drive cycle. The operator may pull off to the side of the road in order to investigate. The operator may determine that the cause of the problem is a flat tire. At this point, the user may desire instructions on how to mount the spare tire. The operator may activate the hazard warning system 202. In response to activation of the hazard warning system 202, the CPU 103 may prompt the operator if the user assist feature should be activated.

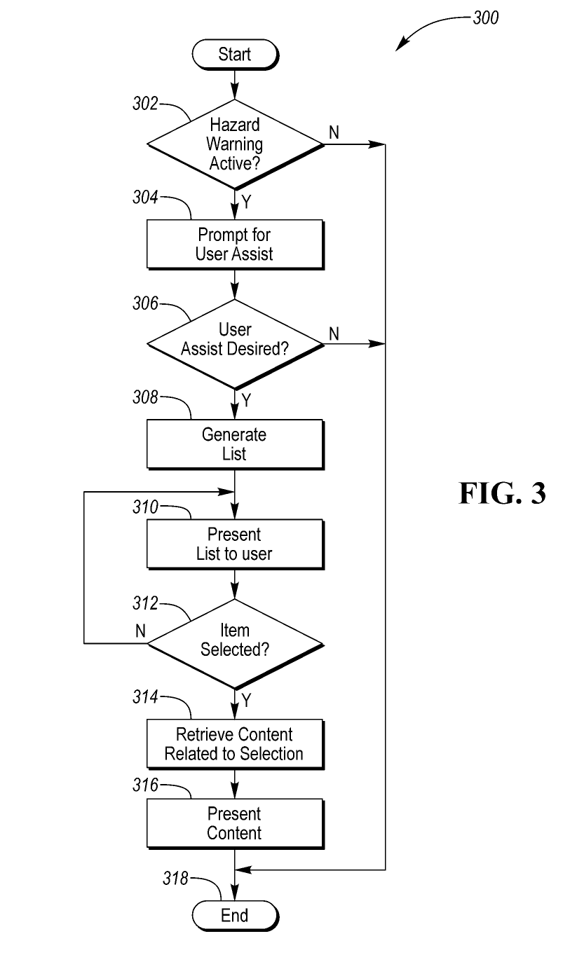

FIG. 3 depicts a flowchart 300 of a possible sequence of operations that may be implemented as part of a user assistance feature. At operation 302, a check may be performed to determine if the hazard warning system 202 is active. The hazard warning system 202 may be active if the hazard lights 208 are turned on due to activation by the hazard switch 206. If the hazard warning system 202 is not active, the user assistance feature may be bypassed (e.g., execution goes to operation 318). If the hazard warning system 202 is active, operation 304 may be performed.

At operation 304, the system may output a prompt for user assistance. For example, the CPU 103 may output a query or assistance request to the display 104 and/or nomadic device 153 asking the operator if the assistance feature should be initiated. The query may include touch sensitive regions of the display 104 and/or display of the nomadic device 153 for corresponding to yes or no. If user assistance is not desired, the user assistance feature may be bypassed.

If user assistance is desired, operation 308 may be performed. At operation 308, the CPU 103 may generate a list of items to present to the user. For example, the list may be a predetermined list of selectable items. In some configurations, the list may be situation sensitive and the order of items in the list may depend upon current conditions of the vehicle. For example, the presence of a MIL 204 may alter the list such that items related to the reason for the MIL 204 being active may be presented first in the list. At operation 310, the list may be presented to the user. In some configurations, the list may be output to the display 104. In some configurations, the list may be transmitted over a wireless link (e.g., BLUETOOTH 115, router 173) to a nomadic device 153 that is in communication via the wireless link. For example, the list may be output to a cell phone that is paired with the vehicle communication system 100. The user may be prompted to select an item within the list using a touchscreen or other input interface.

At operation 312, a check may be performed to determine if an item has been selected. The display 104 or nomadic device 153 may detect a touch of the screen associated with one of the list items. The display 104 or nomadic device 153 may communicate the selection information to the CPU 103. If no item is selected, operation 310 may be repeated to continue to present the list. The list may include an exit or return selection that causes the list to terminate.

If an item is selected, operation 314 may be performed. At operation 314, content related to the selected item may be retrieved. For example, the content may be locally stored in persistent storage 107 as a local database 216 or the content may be retrieved from a remote server 212 that is coupled to a database 214. At operation 316, the content may be presented to the operator via the display 104 and/or the nomadic device 153. The content may include images, text, videos, audio, and any combination thereof. The content may also include DTC information and snapshot data associated with the DTC converted to a displayable format. For example, if the selected content is a video, the video may be streamed to the display 104 and/or nomadic device 153. In some configurations, the CPU 103 may retrieve the content from the remote server 212 via the embedded modem 163. In some configurations, the nomadic device 153 may communicate via a cellular or wireless network to the remote server 212. The CPU 103 may be configured to transmit a link (e.g., internet protocol (IP) address) to the nomadic device 153. The nomadic device 153 may communicate with the remote server 212 and download content provided by the link.

Various operations of the flowchart may be repeated depending upon the list/menu structure. For example, as discussed previously herein, a list may prompt the display of another list which may alter the sequence. That is, some operations may be repeated in context of the new list. In addition, some menu selections may allow the user to back track through the menus.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
a wireless transceiver configured to communicate with a nomadic device; and
a controller programmed to, responsive to activation of vehicle hazard lamps, transmit an assistance request to the nomadic device, and, responsive to receiving a request for assistance from the nomadic device, transmit a list of options for display on the nomadic device, and, responsive to receiving a selected option, transmit content to the nomadic device related to the selected option.

2. The vehicle of claim 1 wherein the content includes step-by-step instructions and images related to the selected option.

3. The vehicle of claim 1 wherein the content includes video related to the selected option.

4. The vehicle of claim 1 wherein the list of options includes one or more observable vehicle conditions.

5. The vehicle of claim 4 wherein the content is directed toward responding to the observable vehicle condition that is the selected option.

6. The vehicle of claim 1 further comprising a display and wherein the controller is further programmed to output the list and the content to the display.

7. The vehicle of claim 1 wherein the content is stored in a non-volatile memory of the controller.

8. The vehicle of claim 1 further comprising a cellular modem, and wherein the controller is further programmed to, responsive to receiving the request for assistance, download the list of options from a remote server via the cellular modem, and, responsive to receiving input indicative of a selected option, download the content related to the selected option from the remote server.

9. The vehicle of claim 1 wherein the controller is further programmed to prioritize the list of options such that options associated with a diagnostic trouble code that is presently illuminating an indicator light are displayed at topmost positions of the list.

10. The vehicle of claim 1 wherein the wireless transceiver is configured as a BLUETOOTH transceiver.

11. The vehicle of claim 1 wherein the wireless transceiver is configured as a wireless Ethernet transceiver.

12. A vehicle communication system comprising:
a controller programmed to, responsive to activation of vehicle hazard lamps, transmit to a nomadic device a list of options such that options associated with a diagnostic trouble code that is presently causing an indicator to illuminate are prioritized first in the list, and responsive to input from the nomadic device indicating a selected list item, transmit content to the nomadic device related to the selected list item.

13. The vehicle communication system of claim 12 wherein the content includes step-by-step instructions and images related to the selected list item.

14. The vehicle communication system of claim 12 wherein the content includes video related to the selected list item.

15. The vehicle communication system of claim 12 wherein the list of options further includes observable vehicle conditions.

16. The vehicle communication system of claim 12 wherein the controller is further programmed to download the list of options and the content from a remote server using a cellular modem.

17. A method comprising:
causing, by a vehicle controller, a nomadic device paired with a vehicle wireless transceiver to display a list of options associated with a diagnostic trouble code that is presently illuminating an indicator light responsive to activation of vehicle hazard lights;
communicating, by the nomadic device, a selected list item to the vehicle controller; and
causing, by the vehicle controller, the nomadic device to display content associated with the selected list item.

18. The method of claim 17 wherein the vehicle controller transmits the content to the nomadic device.

19. The method of claim 17 wherein the vehicle controller transmits a link to the content and the nomadic device retrieves the content via a network interface using the link.

20. The method of claim 17 wherein the content includes at least one of step-by-step instructions, images, and video for responding to the selected list item.
